(19) United States
(12) Patent Application Publication
(10) Pub. No.: US 2025/0150174 A1
(43) Pub. Date: May 8, 2025

(54) CONTROL SIGNAL MULTIPLEXING APPARATUS, CONTROL SIGNAL RECEIVING APPARATUS, CONTROL SIGNAL MULTIPLEXING METHOD, AND CONTROL SIGNAL RECEIVING METHOD

(71) Applicant: NIPPON TELEGRAPH AND TELEPHONE CORPORATION, Tokyo (JP)

(72) Inventor: Manabu YOSHINO, Musashino-shi (JP)

(73) Assignee: NIPPON TELEGRAPH AND TELEPHONE CORPORATION, Tokyo (JP)

(21) Appl. No.: 18/837,492

(22) PCT Filed: Feb. 14, 2022
(86) PCT No.: PCT/JP2022/005614

§ 371 Date: Aug. 9, 2024

(51) Int. Cl. H04B 10/532; H04J 14/06

(52) U.S. Cl. CPC H04B 10/532; H04J 14/06

(57) ABSTRACT

The control signal multiplexing device includes a modulation unit that performs polarization modulation of an optical signal for carrying a main signal with a control signal.

### TECHNICAL FIELD

The present invention relates to a control signal multiplexing device (a control signal multiplexing apparatus), a control signal receiving device (a control signal receiving apparatus), a control signal multiplexing method, and a control signal receiving method.

### BACKGROUND ART

Recently, an optical access network is required to be realized with a low delay by Photonic Gateway (hereinafter referred to as “PG”) (see, for example, NPL 1). A plurality of user devices (CPE: Customer Premises Equipment) is connected to the PG, and a wavelength to be used for each user device is set. Since optical signals of various protocols are inputted to the PG, it is desired to perform wavelength setting and optical path setting for the user device by using a control signal independent of the protocol of the optical signal. A method of using an AMCC (Auxiliary Management Control Channel) is known as a management control method independent of communication protocol of a main signal.

### CITATION LIST

### Non Patent Literature

NPL 1: “Novel System Architecture toward the Realization of All-photonics Network”, The journal of the Institute of Electronics, Information and Communication Engineers Vol. 104 No. 5 pp. 471-477, 2021, <URL: https://www.journal.ieice.org/bin/pdf_link.php?fname=k104_5_471&lang=J&year=2021>

### SUMMARY OF INVENTION

### Technical Problem

As a modulation method of the control signal, a method different from the AMCC has been required. In view of the foregoing circumstances, an object of the present invention is to provide technique capable of performing transfer of the control signal by the method different from the AMCC.

### Solution to Problem

One aspect of the present invention is a multiplexing device that multiplexes a control signal on a main signal by performing polarization modulation and multiplexes the main signal on an optical signal subjected to the polarization modulation by the control signal.

One aspect of the present invention is a control signal receiving device that includes a decoding unit that decodes a control signal on the basis of a polarization state of an optical signal received from the control signal multiplexing device according to the above aspect.

One aspect of the present invention is a control signal multiplexing method that includes a step of performing polarization modulation of an optical signal for carrying a main signal with a control signal.

One aspect of the present invention is a control signal receiving method that includes a step of decoding a control signal on the basis of a polarization state of an optical signal received from the control signal multiplexing device according to the above aspect.

### Advantageous Effects of Invention

According to the above-described aspects, it is possible to perform transfer of the control signal by the method different from the AMCC.

### BRIEF DESCRIPTION OF DRAWINGS

FIG. 1A is a diagram showing a first configuration example of an optical communication system according to an embodiment.

FIG. 1B is a diagram showing a second configuration example of the optical communication system according to the embodiment.

FIG. 1C is a diagram showing a third configuration example of the optical communication system according to the embodiment.

FIG. 2 is a schematic block diagram showing a configuration of a relay device and a user device according to a first embodiment.

FIG. 3 is a diagram showing a configuration example of a detection unit according to the first embodiment.

FIG. 4 is a schematic block diagram showing a configuration of a relay device and a user device according to a second embodiment.

FIG. 5 is a schematic block diagram showing a configuration of a relay device and a user device according to a third embodiment.

FIG. 6 is a schematic block diagram showing a configuration of a relay device and a user device according to a fourth embodiment.

FIG. 7 is a diagram showing an example of a configuration of a DGD modulation unit according to the fourth embodiment.

FIG. 8 is a diagram showing an example of a configuration of a compensation amount derivation unit according to the fourth embodiment.

FIG. 9 is a diagram showing a configuration example of an optical communication system according to the fifth embodiment.

FIG. 10 is a schematic block diagram showing a configuration of an optical distribution device according to the fifth embodiment.

FIG. 11 is a schematic block diagram showing a configuration of a computer according to at least one embodiment.

### DESCRIPTION OF EMBODIMENTS

Embodiments are described in detail below with reference to the drawings. An optical communication system 1 described in the following embodiments includes a control signal multiplexing device M that multiplexes an optical signal for carrying a main signal with a control signal, and a control signal receiving device R that receives the control signal.

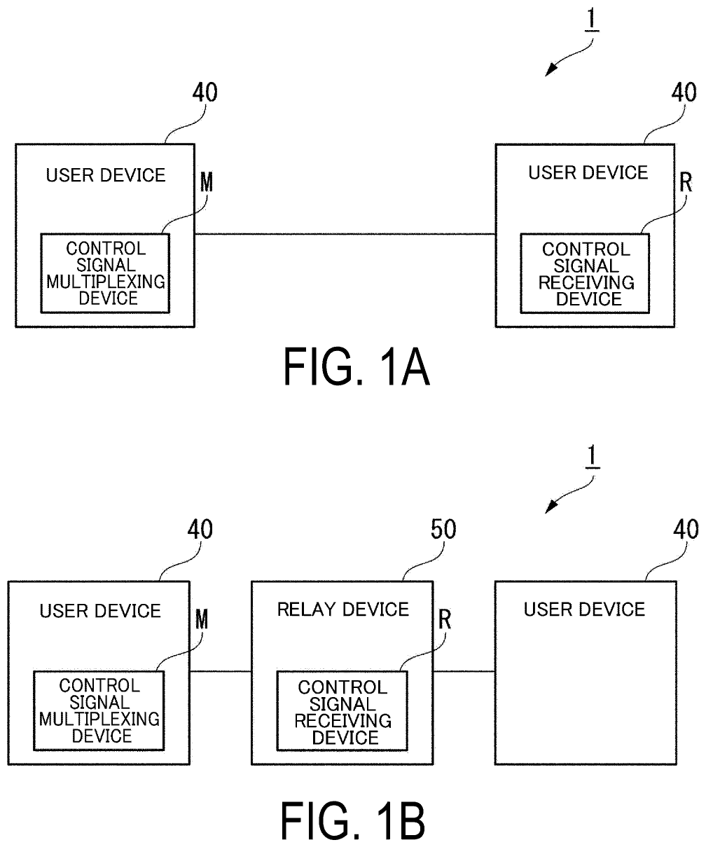

FIG. 1A is a diagram showing a first configuration example of the optical communication system 1 according to an embodiment. The optical communication system 1 may include two user devices 40 as shown in FIG. 1A. The two user devices 40 are connected to each other via a path such as an optical fiber or a spatial transmission line. As an example of the spatial transmission line, FSO (Free Space Optics) can be cited. In the example shown in FIG. 1A, one user device 40 has a function as the control signal multiplexing device M, and the other user device 40 has a function as the control signal receiving device R.

FIG. 1B is a diagram showing a second configuration example of the optical communication system 1 according to the embodiment. The optical communication system 1 may include two user devices 40 and a relay device 50 as shown in FIG. 1B. The user device 40 and the relay device 50 are connected via the optical fiber or the spatial transmission line. In the example shown in FIG. 1B, one of the user devices 40 has a function as the control signal multiplexing device M, and the relay device 50 has a function as the control signal receiving device R.

FIG. 1C is a diagram showing a third configuration example of the optical communication system 1 according to the embodiment. The optical communication system 1 may include two user devices 40 and the relay device 50 as shown in FIG. 1C. In the example shown in FIG. 1C, the relay device 50 has a function as the control signal multiplexing device M, and one of the user devices 40 has a function as the control signal receiving device R.

The user device 40 may be a UT (User Terminal), a CPE, or an ONU (Optical Network Unit), for example. In addition, the relay device 50 may be an OLT (Optical Line Terminal), a GW (Gateway), an optical switch, or the like, for example. Note that, in other embodiments, each of the user device 40 and the relay device 50 may have a function as the control signal multiplexing device M and the control signal receiving device R. In addition, in other embodiments, the user device 40 may have no functions as the control signal multiplexing device and the control signal receiving device, and a plurality of relay devices 50 (for example, Photonic GW) provided on the path may have functions as the control signal multiplexing device M and the control signal receiving device R.

### First Embodiment

A first embodiment will be described below. In the following description, a configuration in which the optical communication system 1 includes two user devices 40 and the relay device 50 as shown in FIG. 1B, and one user device functions as the control signal multiplexing device M, and the relay device 50 functions as the control signal receiving device R will be described as an example.

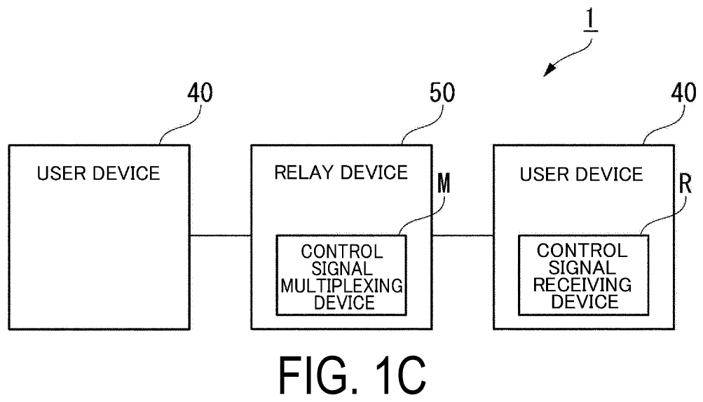

FIG. 2 is a schematic block diagram showing a configuration of the relay device 50 and the user device 40 according to the first embodiment.

The user device 40 includes a main signal modulation unit 41, a control signal generation unit 42, and a polarization modulation unit 44.

The main signal modulation unit 41 generates an optical signal modulated by a main signal. The modulation method of the main signal may be any modulation method which is not affected by polarization modulation. For example, the main signal modulation unit 41 generates the optical signal modulated by the main signal by a direct modulation method or an external modulation method. The direct modulation method is a method in which the direct modulation is performed by modulating current applied to a light source. The external modulation method is a method in which light outputted from the light source is modulated by an external modulator.

The control signal generation unit 42 generates a control signal indicating control information to be notified to the relay device 50.

For example, the control signal generation unit 42 performs the polarization modulation. As the polarization modulation, for example, a control signal before the modulation is read as a binary bit string, and when the bit of the control signal before the modulation is “0”, a first modulation pattern is outputted, and when the bit of the control signal before the modulation is “1”, a second modulation pattern is outputted. Note that one of the first modulation pattern and the second modulation pattern may be non-modulated. In other words, the control signal generation unit 42 may switch the presence or absence of the polarization modulation based on the control signal.

Note that, there is a possibility that the polarization of the control signal according to the first embodiment is varied by external disturbance of the transmission line. Therefore, the control signal generation unit 42 selects a polarization shift of the polarization modulation, for example, a modulation pattern, which is a pattern different enough to be discriminated from the external disturbance. In addition, when a polarization state drifts due to the external disturbance, the control signal generation unit 42 may modulate the signal with change amount from the previous polarization state in order to improve the drift resistance. For example, in the case of binary modulation, the modulation may be performed with a change from the previous polarization state and without a change from the previous polarization state (continuation of the polarization state), or with a large amount of change and a small amount of change from the previous polarization state, or in a direction of the change. Further, the control signal generation unit 42 may perform modulation in accordance with a differential encoding method in which the encoding is performed by the change amount from a previous code value. For example, when a bit of the control signal does not change (“0”→“0” or “1”→“1”), the first modulation pattern may be outputted, and when the bit of the control signal changes (“0”→“1” or “1”→“0”), the second modulation pattern may be outputted.

The modulation pattern will be described in detail later. In addition, in other embodiments, the control signal generation unit 42 may switch the modulation pattern to be outputted when the bit of the control signal before the modulation is “1”, and may not switch the modulation pattern to be outputted when the bit of the control signal before the modulation is “0”. Further, in other embodiments, the control signal generation unit 42 may switch the modulation pattern to be outputted when the bit of the control signal before the modulation is “0”, and may not switch the modulation pattern to be outputted when the bit of the control signal before the modulation is “1”.

The polarization modulation unit 44 performs the polarization modulation of the optical signal outputted by the main signal modulation unit 41 with the modulation pattern outputted by the control signal generation unit 42 and outputs the modulated signal. The optical signal on which the main signal is superimposed is an example of the optical signal for carrying the main signal. Note that although the polarization modulation unit 44 according to the present embodiment modulates the optical signal on which the main signal is superimposed by the external modulation method, but is not limited to this in other embodiments. For example, in other embodiments, the polarization modulation unit 44 may modulate the optical signal in accordance with the main signal and the control signal by using the same modulator as that of the main signal. In addition, in other embodiments, the output of the polarization modulation unit may be inputted to the main signal modulation unit. For example, the polarization modulation unit 44 may generate the optical signal modulated by the control signal by the direct modulation method using the light source in which the polarization of the output light is changed by applied current or the like. In this case, it can be considered that the polarization modulation unit 44 is provided as the light source of the main signal modulation unit 41. The main signal modulation unit 41 modulates the light from the polarization modulation unit 44, which is the light source, with the main signal by, for example, the external modulation method, to output the optical signal in which the control signal and the main signal are multiplexed. Therefore, the optical signal outputted from the polarization modulation unit 44 is modulated later by the main signal, and therefore it can be said as the optical signal for carrying the main signal.

The relay device 50 includes a branching unit 11, a detection unit 12, a decoding unit 14, a control unit 15, and a relay unit 16. An example in which the relay device transparently relays the signal without performing OEO (Optical-Electrical-Optical) conversion will be described below. When the relay is performed, in which an OE (Optical-Electrical) converted signal is subjected to electrical processing and then subjected to EO (Electrical-Optical) conversion, the output of a receiver for receiving both the main signal and the control signal is electrically branched without detecting the light branched by an optical merging/branching unit for receiving the control signal, one may be inputted to the detection unit, and the other may be inputted to the relay unit for performing EO conversion and outputting.

The branching unit 11 is the optical merging/branching unit, branches the optical signal received from the user device 40, and outputs it to the detection unit 12 and the relay unit 16.

The detection unit 12 detects the control signal from the optical signal received from the user device 40 via the branching unit 11. The detection unit 12 is a detection unit capable of detecting a difference in the polarization. Examples of the detection unit 12 include a polarization analyzer, a pair of a polarizer and a light receiver, and the like.

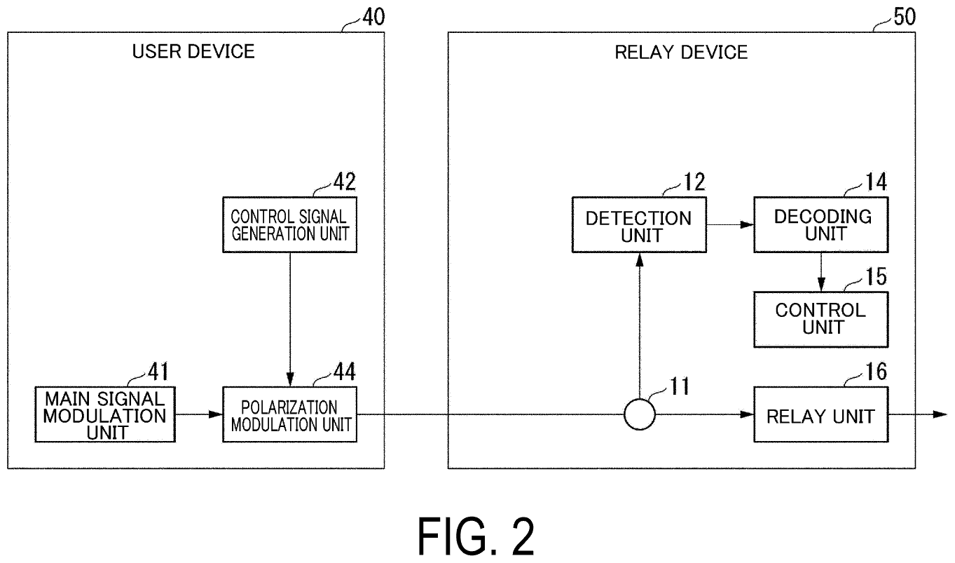

FIG. 3 is a diagram showing a configuration example of the detection unit 12 according to the first embodiment. For example, as shown in FIG. 3, the detection unit 12 may be a differential detection circuit including a PBS 121 (Polarization Beam Splitter), a first light receiver 122 and a second light receiver 123. The differential detection circuit detects an intensity difference between both linear polarizations when the polarization made incident on the PBS 121 is split into two linear polarizations. The first light receiver 122 and the second light receiver 123 are realized by, for example, a PD (photodiode) or an APD (avalanche photodiode). The light receiving characteristics of the first light receiver 122 and the second light receiver 123 are substantially equal to each other. Note that when there is a difference in the light receiving characteristics between the first light receiver 122 and the second light receiver 123, the difference in the light receiving characteristics may be canceled by multiplying a gain corresponding to reciprocal of the light receiving characteristics at the subsequent stage of the light receiver. The first light receiver 122 receives a polarization component, for example, a p-polarized light component of the optical signal split from the PBS 121. The second light receiver 123 receives a polarization component, for example, an s-polarized light component of the optical signal split from the PBS 121. The first light receiver 122 and the second light receiver 123 constitute a balance type light receiver connected in series in the same polarity direction.

As a result, the detection unit 12 shown in FIG. 3 can obtain a differential output of two orthogonal polarization components of the optical signal, for example, the p-polarized light component and the s-polarized light component. In addition, the detection unit 12 may be constituted by a light receiver for detecting only one polarization component of the optical signal, for example, one polarization of either the p-polarized light component or the s-polarized light component. In this case, however, the detection sensitivity is substantially half as compared with the detection unit 12 shown in FIG. 3. Further, for example, the detection unit 12 may be a polarization monitor for determining amplitude and a phase of the p-polarized light component and the s-polarized light component by measuring power (stokes parameters S0-S4) of four independent polarization states.

Note that although the optical signal is subjected to orthogonal polarization modulation and differential detection by orthogonal polarization in the present embodiment, the differential detection may be performed according to the modulation value. For example, in other embodiments, the optical signal may be modulated by a circular polarization, and the circular polarization in the opposite direction may be received, respectively, and detected by the differential detection.

The decoding unit 14 decodes the signal outputted by the detection unit 12 into a bit string. Note that when the user device 40 encodes the control signal by the differential encoding method, the bit string of the control signal is decoded based on the previous bit value. Note that when the main signal does not perform the polarization multiplexing or the polarization modulation and the frequency is different between the first modulation pattern and the second modulation pattern, the decoding unit 14 performs pattern synchronization for detecting an output of intensity locked in the frequency related to the modulation pattern, and may perform the above-described decoding.

The control unit 15 controls the relay device 50 on the basis of the control signal decoded by the decoding unit 14. For example, when the control signal from the user device 40 indicates a wavelength request message, the control unit 15 allocates a usable wavelength to the user device 40. Note that the control unit 15 may allocate or change the wavelength even when there is no wavelength request message from the user device 40.

The relay unit 16 outputs the optical signal outputted from the branching unit 11 to the opposite user device 40.

### <<Modulation Pattern>>

The control signal generation unit 42 of the user device 40 may switch the modulation pattern to be outputted between the first modulation pattern and the second modulation pattern on the basis of the control signal.

For example, the first modulation pattern may be the p-polarization, and the second modulation pattern may be the s-polarization.

For example, the first modulation pattern may be the linear polarization, and the second modulation pattern may be the circular polarization. For example, the first modulation pattern and the second modulation pattern may be the circular polarization of reverse rotation.

For example, the first modulation pattern may be a pattern for changing a polarization angle of a polarization plane of the optical signal of the linear polarization at a first frequency in a first variation range (amplitude). A state in which the polarization angle changes at the first frequency in the first variation range is an example of the first polarization state. The second modulation pattern is, for example, a pattern for changing the polarization angle of the polarization plane of the optical signal of the linear polarization at a second frequency in a second variation range. A state in which the polarization angle changes at the second frequency in the second variation range is an example of the second polarization state. The second modulation pattern is a modulation pattern in which at least one of the variation ranges and the frequency of the polarization angle is different from that of the first modulation pattern.

Here, the variation range of each modulation pattern in the first embodiment is different from the range of the polarization variation due to the external disturbance which may occur in the transmission line connecting the user device 40 and the relay device 50. That is, in the case of the change width, the maximum value of the variation range of the modulation pattern is smaller than the minimum value of the range of the polarization variation due to the external disturbance, or the minimum value of the variation range of the modulation pattern is larger than the maximum value of the range of the polarization variation due to the external disturbance. In the case of the frequency, the maximum value of the frequency of the variation of the modulation pattern is smaller than the minimum value of the frequency of the polarization variation due to the external disturbance, or the minimum value of the frequency of the variation range of the modulation pattern is larger than the maximum value of the frequency of the polarization variation due to the external disturbance.

For example, when the polarization variation occurs in a maximum range of ±10 degrees in the transmission line, a range exceeding ±20 degrees, which is twice the range, for example, ±90 degrees is determined as the variation range of the first modulation pattern. In the transmission line in which birefringence is uniformly distributed, the distribution of DGD (Differential Group Delay, group delay time difference) changes forms a Maxwell distribution, so that a range separated by two times (2 σ) or more of the deviation of the distribution of the DGD changes is defined as the variation range.

In addition, the frequency of each modulation pattern in the first embodiment is higher than the frequency of polarization variation which may occur in the transmission line connecting the user device 40 and the relay device 50. For example, when the polarization variation occurs at a frequency of 10 kHz at the maximum in the transmission line, a frequency higher than 10 kHz (for example, 40 kHz) is determined as the frequency of the first modulation pattern.

Note that, in the first embodiment, both the range of the polarization variation and the frequency of the polarization variation in the modulation pattern are made significantly different from the polarization variation due to the external disturbance, but is not limited this. For example, in other embodiments, when the range of the polarization variation in the modulation pattern is significantly different from the polarization variation due to the external disturbance, the frequency of the polarization variation in the modulation pattern may be approximately the same as the polarization variation due to the external disturbance. In addition, when the frequency of the polarization variation in the modulation pattern is significantly different from the polarization variation due to the external disturbance, the range of the polarization variation in the modulation pattern may be approximately the same as the polarization variation due to the external disturbance.

The modulation pattern may be a sine wave, or may be an arbitrary pattern such as a rectangular wave, a sawtooth wave, or a predetermined bit pattern.

For example, when the first modulation pattern has the variation range of ±45 degrees and the frequency of 40 kHz, the second modulation pattern can have the variation range of ±90 degrees and the frequency of 20 kHz or the like.

The optical communication system 1 may have an optical amplifier in the transmission line connecting the user device 40 and the relay device 50. The optical amplifier selects an optical amplifier which does not modulate the signal light into non-polarized light. This is because the control signal disappears when the optical amplifier modulates the signal light into the non-polarized light. Therefore, the polarization modulation may be performed by the optical amplifier if the modulation by the optical amplifier does not interfere with the modulation of the control signal in the present application device. For example, the optical amplifier may perform the polarization modulation at a frequency that can be sufficiently discriminated from a frequency related to a modulation or a modulation pattern of the control signal different from the modulation of the present application device, for example, at a sufficiently low frequency (for example, a frequency of a degree of polarization variation which can occur in the transmission line) or at a sufficiently high frequency. For example, if the modulation frequency of the control signal is several tens kHz, the optical amplifier may perform the polarization modulation at a frequency of several kHz or more corresponding to about 10 ms of an excitation life of Erbium ion in a countermeasure against polarization dependent loss.

### Action and Effect

Thus, the user device 40 according to the first embodiment modulates the polarization state of the optical signal based on the control signal. When the modulation pattern is switched between the first modulation pattern and the second modulation pattern, for example, the modulation pattern according to the first embodiment changes the polarization angle within a predetermined range in accordance with a predetermined frequency. According to the first embodiment, the range of the polarization angle and the frequency of the polarization variation are made significantly different from the polarization variation due to the external disturbance which may occur in the transmission line of the optical signal. Thus, the relay device 50 can receive the polarization variation due to the external disturbance and the control signal while distinguishing them from each other. Note that, in other embodiments, either the range of the polarization angle and the frequency of the polarization variation may be approximately the same as the polarization variation due to the external disturbance.

Although the above example in which the relay device 50 transparently relays the signal without the OEO conversion has been described, when the OE converted signal is electrically processed and then subjected to the EO conversion and relayed, an output of the receiver (user device 40) for receiving both the main signal and the control signal without detecting the light branched by the optical merging/branching unit for receiving the control signal may be electrically branched. In this case, the branching unit is an electric merging/branching unit, branches the optical signal photoelectrically converted by the receiver and outputs the branched signal to a processing unit that decodes the control signal and a processing unit that perform 3R processing or the like on the main signal. The processing in the decoding processing unit is the same.

### Second Embodiment

The optical communication system 1 according to the first embodiment performs the polarization modulation of the optical signal with the control signal. The optical communication system 1 according to a second embodiment realizes transmission of the control signal by the polarization modulation even when transmitting the main signal by polarization multiplexing or polarization modulation.

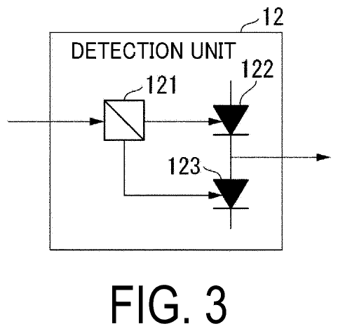

FIG. 4 is a schematic block diagram showing a configuration of the relay device 50 and the user device 40 according to the second embodiment. The user device 40 according to the second embodiment has, for example, the same configuration as that of the first embodiment.

A polarization shift of modulation by the control signal generation unit 42 of the user device 40 according to the second embodiment is larger than a range of the polarization variation due to the external disturbance which may occur in the transmission line connecting the user device 40 and the relay device 50. When the main signal is subjected to the polarization compensation in the opposite device or the relay device 50, the variation range of the modulation pattern should be a range in which the polarization compensation by the polarization compensation unit 13 can be performed.

Further, the frequency of the polarization modulation according to the second embodiment, for example, the frequency of each modulation pattern is higher than the frequency of the polarization variation which may occur in the transmission line connecting the user device 40 and the relay device 50, and lower than the maximum frequency which can be guaranteed by the polarization compensation unit 13 of the opposite device or the relay device 50. For example, when the polarization variation occurs at a frequency of 10 kHz at the maximum in the transmission line and the polarization variation of 50 kHz at the maximum can be compensated in the polarization compensation unit 13, a frequency (for example, 40 kHz) higher than 10 kHz and lower than 50 kHz is determined as the frequency of the first modulation pattern. In the case where the main signal is subjected to the polarization modulation, the frequency of the modulation pattern should be one that can discriminate between the control signal and the main signal. For example, the frequency of the modulation pattern may be frequency multiplexable with the main signal. In addition, for example, the frequency of the modulation pattern may be an integer multiple of the frequency of the main signal, and the modulation pattern may be averaged at the time of reception, so that the decoding of the main signal may not be disturbed.

Note that, in the second embodiment, both the range of the polarization variation and the frequency of the polarization variation in the modulation pattern are made significantly different from the polarization variation due to the external disturbance, but is not limited this. For example, in other embodiments, the range of the polarization variation in the modulation pattern is significantly different from the polarization variation due to the external disturbance, and the frequency of the polarization variation in the modulation pattern may be approximately the same as the polarization variation due to the external disturbance. Further, the frequency of the polarization variation in the modulation pattern is significantly different from the polarization variation due to the external disturbance, and the range of the polarization variation in the modulation pattern may be approximately the same as the polarization variation due to the external disturbance.

The modulation pattern may be the sine wave, or may be the arbitrary pattern such as the rectangular wave, the sawtooth wave, or the predetermined bit pattern.

The opposite device or the relay device 50 according to the second embodiment further includes the polarization compensation unit 13 in addition to the configuration of the first embodiment. In the following, an example in which the polarization compensation unit 13 compensates based on the control signal received by the relay device on the assumption of transparent transmission will be described. The polarization compensation unit 13 compensates for the polarization of the optical signal received from the user device 40 via the branching unit 11.

In addition, the polarization compensation unit 13 may be constituted by, for example, a polarization controller, a polarization delay unit, and a polarization monitor. As the polarization controller, it is preferable to use a controller (infinite following type) capable of following all polarization variations without being saturated continuously. As the polarization controller, for example, a micro-optics type using a dielectric crystal, a fiber type for controlling tension to a fiber by piezo or the like, and a PLC (Planar Lightwave Circuit) type using LiNbO₃ crystal or glass material can be used. The polarization delay unit may be, for example, a polarization maintaining fiber or a delay unit capable of varying a delay time. The polarization monitor determines the amplitude and the phase of the p-polarized light component and the s-polarized light component by measuring power (stokes parameters S₀-S₄) of four independent polarization states.

Note that the decoding unit 14 according to the second embodiment decodes the signal outputted by the detection unit 12 into a bit string. Note that when the user device 40 encodes the control signal by the differential encoding method, the bit string of the control signal is decoded based on the previous bit value. For example, when the sign of the bit is expressed by the differential of the intensity difference between the polarizations, the decoding unit 14 decodes the bit string of the control signal on the basis of the intensity difference between the previous polarizations and the intensity difference between the current polarizations.

### Action and Effect

As described above, according to the second embodiment, the polarization modulation of the control signal is suppressed to such an extent that it can be compensated by the opposite receiving device or the relay device. Thus, the optical communication system 1 can compensate for the polarization modulation by the control signal and prevent the control signal from affecting the main signal even if the protocol of the main signal is accompanied by the polarization modulation or the polarization multiplexing which may be affected by the polarization modulation of the control signal.

Note that although the polarization compensation unit 13 according to the second embodiment compensates for both the control signal and the polarization variation, but is not limited to this. For example, the polarization compensation unit 13 according to other embodiments may compensate for only the control signal in the polarization compensation unit 13 to leave the polarization variation. In this case, the configuration of the polarization compensation unit 13 can be simplified. Further, the polarization compensation unit 13 according to other embodiments may compensate for only the polarization variation without compensating for the control signal.

Further, the relay device 50 according to the second embodiment performs the polarization compensation of the optical signal in the transparent transmission, but is not limited to this in other embodiments. For example, in the case where the relay device 50 performs the OEO and relays or in the case where the opposite device receives the control signal, the polarization compensation may be performed when the main signal is received. For example, the polarization compensation unit 13 may perform PMD (Polarization Mode Dispersion) compensation by digital coherent transmission. As described above, since the polarization modulation unit 44 performs the polarization modulation only within the range in which the polarization compensation unit 13 can compensate, the polarization compensation unit 13 can suppress the control signal from affecting the main signal.

### Third Embodiment

In the relay device 50 according to the first and second embodiments, the detection unit 12 detects the control signal from the optical signal. On the other hand, the relay device 50 according to the third embodiment has a function of obtaining the control signal in the polarization compensation unit 13. The polarization compensation unit 13 of the third embodiment detects a change in the polarization and compensates in accordance with the information of the detected change, and is configured to be able to output the information of the change itself or the information of the compensation.

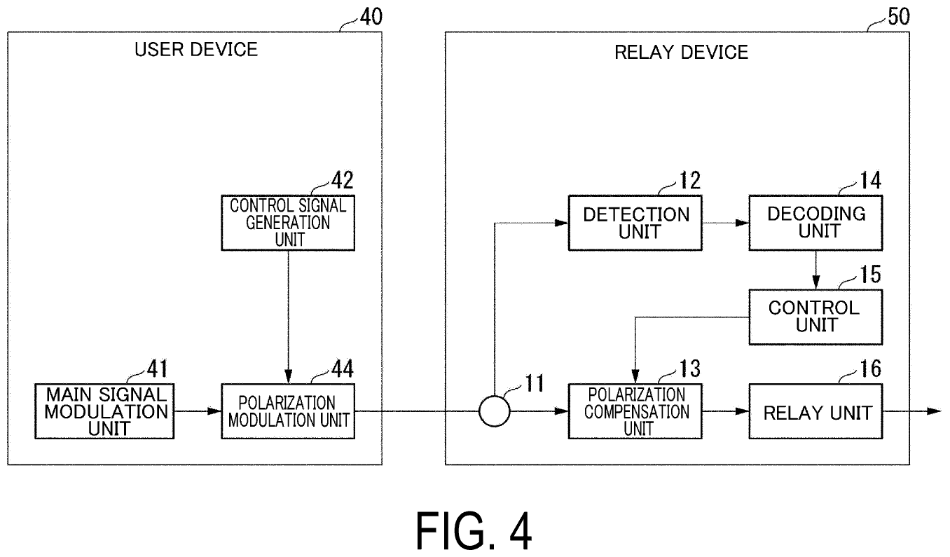

FIG. 5 is a schematic block diagram showing a configuration of the relay device 50 and the user device 40 according to a third embodiment.

The relay device 50 according to the third embodiment does not include the branching unit 11 and the detection unit 12 of the configuration of the second embodiment. The decoding unit 14 according to the third embodiment obtains the control signal superimposed on the optical signal by observing information on the polarization compensation by the polarization compensation unit 13. Specifically, the decoding unit 14 extracts the control signal corresponding to a specific polarization variation deviating from a value of a normal polarization variation. When outputting a compensation signal, the polarization compensation unit 13 extracts an inverted value thereof. That is, the decoding unit 14 according to the third embodiment detects a pattern inverted from that of the decoding units 14 according to the first and second embodiments as a bit pattern or the like.

Note that when the polarization compensation unit 13 outputs the information on the change itself of the polarization, the decoding unit 14 extracts a control signal corresponding to the specific polarization variation deviating from the value of the normal polarization variation. That is, the decoding unit 14 according to the third embodiment detects the same pattern as that of the decoding unit 14 according to the first and second embodiments as the bit pattern or the like.

The variation range of the modulation pattern by the control signal generation unit 42 of the user device 40 according to the third embodiment is larger than the range of the polarization variation due to the external disturbance which may occur in the transmission line connecting the user device 40 and the relay device 50. Note that when the polarization modulation of the control signal may affect the main signal in the case where the main signal is subjected to the polarization modulation or the polarization multiplexing, or the like, the range which can be compensated by the polarization compensation unit 13 is the upper limit of the modulation of the control signal.

Note that, in other embodiments, the rate of change in the modulation pattern may be set to be faster than the rate of change in the polarization variation due to the external disturbance. At this time, when the main signal is subjected to the polarization modulation, the rate of change of the modulation pattern is set to a rate so that it can be discriminated from the polarization modulation of the main signal. In this case, the variation range of the modulation pattern may be approximately the same as the range of the polarization variation due to the external disturbance or may be larger than the range of the polarization variation due to the external disturbance.

In addition, the frequency of each modulation pattern according to the third embodiment is higher than the frequency of the polarization variation which may occur in the transmission line connecting the user device 40. Further, the frequency of each modulation pattern is lower than the maximum frequency that can be guaranteed by the polarization compensation unit 13 of the corresponding device or the relay device 50. For example, when the polarization variation occurs at a frequency of 10 kHz at the maximum in the transmission line and the polarization variation of 50 kHz at the maximum can be compensated in the polarization compensation unit 13, a frequency (for example, 40 kHz) higher than 10 kHz and lower than 50 kHz is determined as the frequency of the first modulation pattern.

Note that, in the third embodiment, both the range of the polarization variation and the frequency of the polarization variation in the modulation pattern are made significantly different from the polarization variation due to the external disturbance, but is not limited thereto. For example, in other embodiments, the range of the polarization variation in the modulation pattern is significantly different from the polarization variation due to the external disturbance, and the frequency of the polarization variation in the modulation pattern may be approximately the same as the polarization variation due to the external disturbance. Further, the frequency of the polarization variation in the modulation pattern is significantly different from the polarization variation due to the external disturbance, and the range of the polarization variation in the modulation pattern may be approximately the same as the polarization variation due to the external disturbance.

The modulation pattern may be the sine wave, or may be the arbitrary waveform such as the rectangular wave, the sawtooth wave, the predetermined bit pattern.

As described above, according to the third embodiment, the relay device 50 obtains the control signal superimposed on the optical signal by observing the polarization compensation amount by the polarization compensation unit 13. Thus, the relay device 50 according to the third embodiment can obtain the control signal without detecting the optical signal by the detection unit 12.

### Fourth Embodiment

The modulation patterns according to the first to third embodiments change the polarization state at a predetermined frequency. On the other hand, in the modulation pattern according to a fourth embodiment, the DGD is changed at a predetermined frequency.

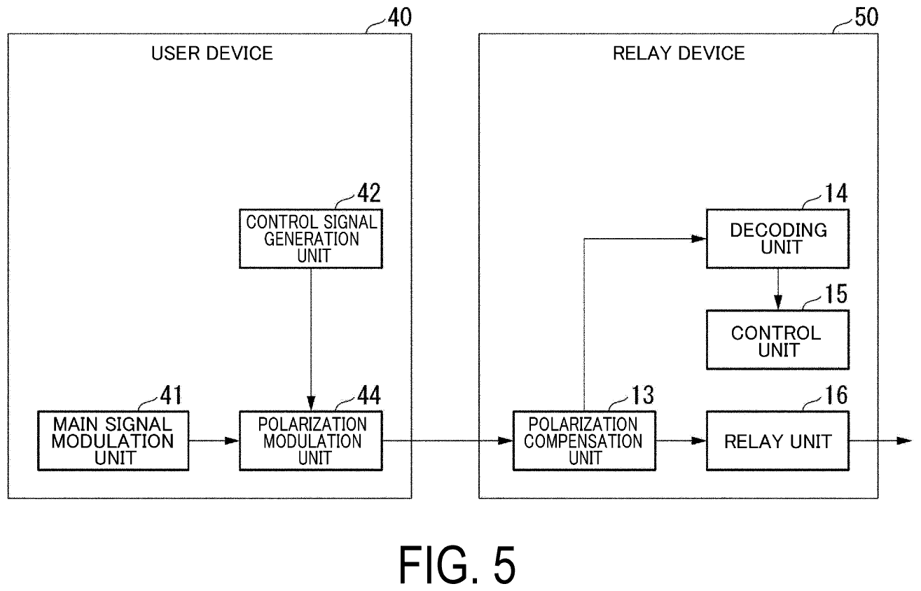

FIG. 6 is a schematic block diagram showing a configuration of the relay device 50 and the user device 40 according to the fourth embodiment.

The user device 40 according to the fourth embodiment includes a DGD modulation unit 45 instead of the polarization modulation unit 44 according to the first embodiment. The DGD modulation unit 45 switches between the first modulation pattern and the second modulation pattern for changing a DGD which is a deviation amount between the p-polarized light component and the s-polarized light component of the optical signal. The modulation by the DGD is an example of the polarization modulation.

The DGD modulation unit 45 may perform the modulation by changing a delay amount due to the polarization. Further, the modulation pattern may be a pattern for changing the DGD at a predetermined frequency within a predetermined variation range, for example. One of the plurality of modulation patterns should be a modulation pattern that differs from the other in at least one of the DGD variation range and frequency from each other.

The variation range of the modulation pattern is a range which is equal to less than the DGD at the maximum which can be guaranteed by the DGD compensation unit 18. In addition, the frequency of each modulation pattern is lower than the maximum frequency which can be guaranteed by the DGD compensation unit 18.

Note that, in the fourth embodiment, both the variation range of the DGD and the frequency of the DGD in the modulation pattern are made significantly different from those of the DGD due to the external disturbance, but is not limited this. For example, in other embodiments, the range of the DGD in the modulation pattern is significantly different from the DGD due to the external disturbance, and the frequency of the DGD in the modulation pattern may be approximately the same as the DGD due to the external disturbance. Further, the frequency of the DGD in the modulation pattern is significantly different from that of the DGD due to the external disturbance, and the range of the DGD in the modulation pattern may be approximately the same as that of the DGD due to the external disturbance.

The modulation pattern may be the sine wave, or may be the arbitrary pattern such as the rectangular wave, the sawtooth wave, the predetermined bit pattern.

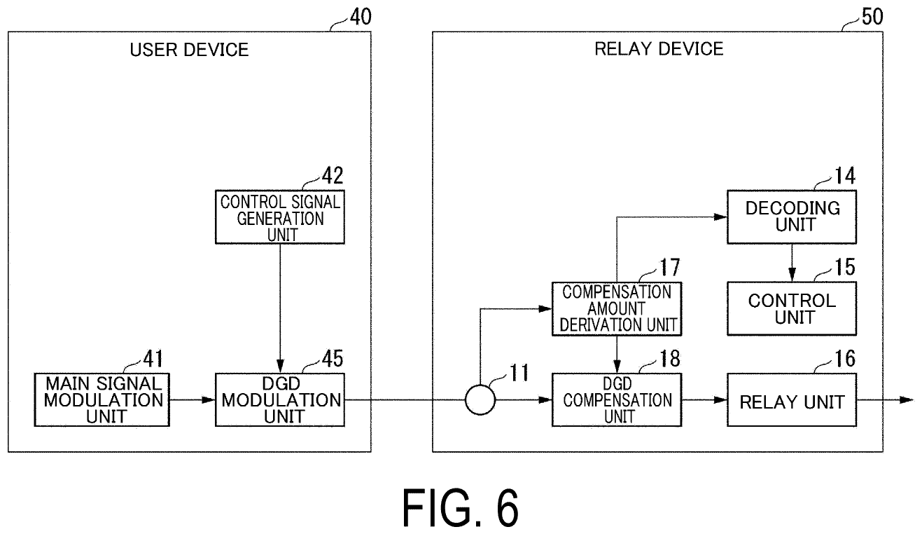

FIG. 7 is a diagram showing an example of a configuration of the DGD modulation unit 45 according to the fourth embodiment. In FIG. 7, the optical signal is represented by a broken line. In FIG. 7, a symbol representing a black circle in a white circle attached on the path of the optical signal indicates that the polarization plane of the optical signal is directed in the vertical direction. In FIG. 7, a symbol representing an arrow in a white circle attached on the path of the optical signal indicates that the polarization plane of the optical signal is directed in the horizontal direction.

The DGD modulation unit 45 includes a PBS 441, a first quarter-wavelength plate 442, a first reflection mirror 443, a second quarter-wavelength plate 444, a second reflection mirror 445 and an actuator 446. Each configuration of the DGD modulation unit 45 is constituted by, for example, MEMS.

The PBS 441 splits the light inputted to the DGD modulation unit 45 into a first polarized light component and a second change component orthogonal to each other.

On the optical path of the first polarized light component split by the PBS 441, the first quarter-wavelength plate 442 and the first reflection mirror 443 are provided so as to be orthogonal to the optical path. Thus, the polarized light plane is inclined by 45 degrees since the first polarized light component passes through the first quarter-wavelength plate 442, and the polarized light plane is further inclined by 45 degrees since the first polarized light component passes through the first quarter-wavelength plate 442 again after being reflected by the first reflection mirror 443. Then, the first polarized light component is made incident on the PBS 441 again. That is, the first polarized light component is made incident on the PBS 441 again in a state of flying twice distance between the PBS 441 and the first reflection mirror 443 and of being inclined by 90 degrees.

On the optical path of the second polarized light component split by the PBS 441, the second quarter-wavelength plate 444 and the second reflection mirror 445 are provided so as to be orthogonal to the optical path. Thus, the polarized light plane is inclined by 45 degrees since the second polarized light component passes through the second quarter-wavelength plate 444, and the polarized light plane is further inclined by 45 degrees since the second polarized light component passes through the second quarter-wavelength plate 444 again after being reflected by the second reflection mirror 445. Then, the second polarized light component is made incident on the PBS 441 again. That is, the second polarized light component is made incident on the PBS 441 again in a state of flying twice distance between the PBS 441 and the second reflection mirror 445 and of being inclined by 90 degrees.

The first reflection mirror 443 is configured so that a relative position to the PBS 441 can be changed by the actuator 446. The actuator 446 moves the first reflection mirror 443 in a direction along the optical path of the first polarized light component.

On the other hand, the second reflection mirror 445 is fixed so as not to change the relative position to the PBS 441.

Thus, the optical path length of the first polarized light component is relatively changed with respect to the optical path length of the second polarized light component by driving the actuator 446.

The DGD modulation unit 45 can multiplex the control signal on the optical signal by driving the actuator 446 in accordance with the modulation pattern outputted by the control signal generation unit 42.

Note that although the DGD modulation unit 45 shown in FIG. 7 modulates the optical signal on which the main signal is superimposed by the external modulation method, but is not limited to this in other embodiments. The DGD modulation unit 45 may use a combination of a light source in which the polarization of the output light is changed by applied current or the like and a delay line depending on the polarization. In addition, the DGD modulation unit 45 may be a combination of a polarization modulator and the delay line depending on the polarization. Note that, in the case where the DGD modulator 45 shown in FIG. 7 is used, the modulation pattern which continuously changes such as the sine wave is suitable.

In addition, as shown in FIG. 6, the corresponding device or the relay device 50 according to the fourth embodiment includes a compensation amount derivation unit 17 and a DGD compensation unit 18 instead of the detection unit 12 of the first embodiment.

For example, when the relay device 50 according to the fourth embodiment performs the OEO conversion and the polarization compensation unit 13 performs the electrical PMD compensation after reception, such as digital coherent transmission, for example, the decoding unit 14 obtains the time series of the DGD of the optical signal by observing the magnitude of the compensation of the DGD (tap coefficient of the FIR filter) derived by the compensation amount derivation unit 17.

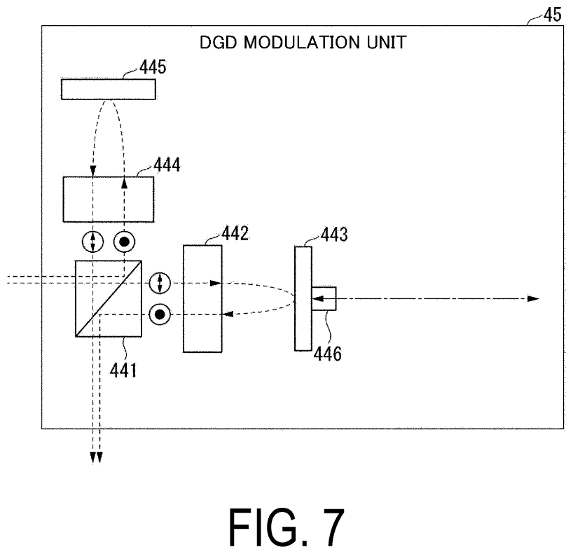

FIG. 8 is a diagram showing an example of a configuration of the compensation amount derivation unit 17 according to the fourth embodiment. The compensation amount derivation unit 17 according to the fourth embodiment has butterfly filters for realizing polarization multiplexing transmission.

Specifically, the compensation amount derivation unit 17 includes a first FIR filter Pxx, a second FIR filter Pxy, a third FIR filter Pyx, a fourth FIR filter Pyy, a first adder Ax, a second adder Ay, a first update unit Ux, and a second update unit Uy.

The first FIR filter Pxx multiplies the p-polarized light component of the received optical signal by a predetermined gain. The tap coefficient of the first FIR filter Pxx is updated by the first update unit Ux.

The second FIR filter Pxy multiplies the s-polarized light component of the received optical signal by the predetermined gain. The tap coefficient of the second FIR filter Pxy is updated by the first update unit Ux.

The third FIR filter Pyx multiplies the p-polarized light component of the received optical signal by the predetermined gain. The tap coefficient of the third FIR filter Pyx is updated by the second update unit Uy.

The fourth FIR filter Pyy multiplies the s-polarized light component of the received optical signal by the predetermined gain. The tap coefficient of the fourth FIR filter Pyy is updated by the second update unit Uy.

The first adder Ax adds the output of the first FIR filter Pxx and the output of the second FIR filter Pxy.

The second adder Ay adds the output of the third FIR filter Pyx and the output of the fourth FIR filter Pyy.

The first update unit Ux updates tap coefficients of the first FIR filter Pxx and the second FIR filter Pxy so as to minimize a square average error with a predetermined reference signal. The second update unit Uy updates tap coefficients of the third FIR filter Pyx and the fourth FIR filter Pyy so as to minimize the square average error with the predetermined reference signal.

Note that, in the modulation method with a constant envelope, the first update unit Ux and the second update unit Uy may use a CMA (Constant Modulus Algorithm) using a constant as the reference signal for the least-square average error.

The output of the circuit constituted by such FIR filters and adders is expressed by an equation (1).

$$\begin{matrix}[ Math . 1 ] & \\ [ \begin{matrix}{O}_{X i} \\ {O}_{Y i}\end{matrix} ] = [ \begin{matrix}P x x & P x y \\ P y x & P y y\end{matrix} ] [ \begin{matrix}{r}_{X i} \\ {r}_{Y i}\end{matrix} ] & ( 1 )\end{matrix}$$

Here, o_{Xi} is a value of the p-polarized light component of the signal compensated by the compensation amount derivation unit 17. o_{Yi} is a value of the s-polarized light component of the signal compensated by the compensation amount derivation unit 17. r_{Xi} is a value of the p-polarized light component of the signal to be inputted to the compensation amount derivation unit 17. r_{Yi} is a value of the s-polarized light component of the signal to be inputted to the compensation amount derivation unit 17. The first update unit Ux and the second update unit Uy set the tap coefficients of each FIR filter so that the matrix [Pxx, Pxy; Pyx, Pyy] of the above-described equation (1) normalizes a square matrix representing the polarization variation in the transmission line. Thus, the compensation amount derivation unit 17 can calculate the compensation amount of the polarization variation in the transmission line.

The decoding unit 14 identifies the DGD of the received optical signal by observing each tap coefficient to be set by the first update unit Ux and the second update unit Uy of the compensation amount derivation unit 17. The decoding unit 14 decodes the control signal on the basis of the time series of the identified DGD.

In addition, the DGD compensation unit 18 compensates for the DGD of the optical signal outputted from the branching unit 11 in accordance with each tap coefficient to be set by the first update unit Ux and the second update unit Uy of the compensation amount derivation unit 17. For example, the DGD compensation unit 18 may be realized in the same configuration as that of the DGD modulation unit 45 shown in FIG. 7.

Note that, in other embodiments, the relay device 50 may include an electro-optic converter at the subsequent stage of the compensation amount derivation unit 17 instead of the branching unit 11 and the DGD compensation unit 18. In other words, the relay device 50 according to other embodiments may convert the s-polarized light component o_{Xi} and the p-polarized light component o_{Yi} outputted by the compensation amount derivation unit 17 into the optical signal.

### Fifth Embodiment

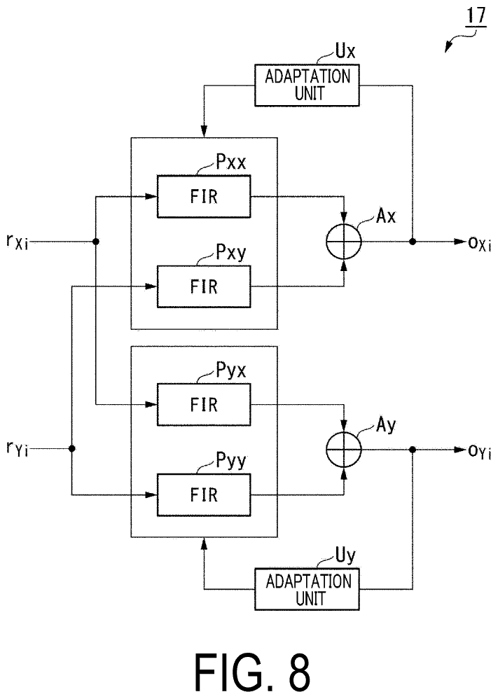

FIG. 9 is a diagram showing a configuration example of the optical communication system 1 according to a fifth embodiment. The optical communication system 1 according to the fifth embodiment includes a plurality of optical distribution devices 10, a control device 20, an optical communication network 30, and a plurality of user devices 40. That is, in the fifth embodiment, the optical communication network 30 is provided between the user device 40 functioning as the control signal multiplexing device M and the user device 40 functioning as the control signal receiving device R shown in FIG. 1A. In FIG. 9, the optical communication system 1 includes the optical distribution device 10-1 and the optical distribution device 10-2, but the number of the optical distribution devices 10 is not limited to this. The optical distribution device 10 is connected to the control device 20. The optical distribution device 10 and other optical distribution devices 10 communicate with each other via the optical communication network 30. The optical communication network 30 may use, for example, a WDM (Wavelength Division Multiplexing) network including various topologies and the like. One or more user devices 40 are connected to the optical distribution device 10. The optical distribution device 10, the control device 20, and the optical communication network 30 constitute a relay system 2 for relaying the communication between the user devices 40.

The control device 20 allocates each wavelength used by the user device 40 in response to connection request from the user device 40. The control device 20 transmits setting information such as a wavelength to be used to each user device 40. The relay system 2 and the user device 40 transfer the control information including the above-described setting information in order to transmit the main signal of the user device 40.

In the optical communication system 1 according to the first to fourth embodiments, the control signal is transferred between the user device 40 and the relay device 50. On the other hand, the optical distribution device 10 related to the optical communication system 1 shown in FIG. 9 may not only receive the control signal from the user device 40 but also transmit the control signal to another optical distribution device 10 which is the transmission destination of the optical signal. The optical communication system 1 according to the fifth embodiment will be described with reference to the case where the control signal is erased and overwritten on the way of the path of the optical signal. Specifically, the optical distribution device 10-1 shown in FIG. 9 erases the control signal received from the user device 40 from the optical signal, and adds the control signal to the optical signal for transmission to the optical distribution device 10-2 which is the transmission destination of the optical signal.

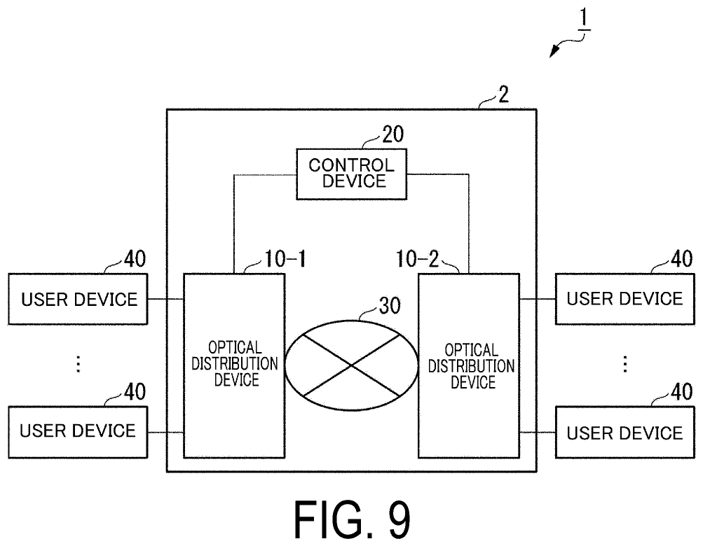

FIG. 10 is a schematic block diagram showing a configuration of the optical distribution device 10 according to the fifth embodiment. The optical distribution device 10 according to the fifth embodiment includes the branching unit 11, the detection unit 12, the polarization compensation unit 13, the decoding unit 14, the control unit 15, the control signal generation unit 21, the polarization modulation unit 22, and an optical SW 23. In the following, an example in which the optical distribution device 10 according to the fifth embodiment performs the OEO conversion of the optical signal will be described.

The branching unit 11 branches the received optical signal and outputs it to the detection unit 12 and the polarization compensation unit 13. The detection unit 12 detects the control signal from the optical signal inputted from the branching unit 11. The polarization compensation unit 13 compensates for the polarization of the optical signal inputted from the branching unit 11. The polarization compensation unit 13 performs the PMD compensation by, for example, the digital coherent transmission. In the case of performing the PMD compensation by the digital coherent transmission, the polarization compensation unit 13 is suitable for a configuration in which the input signal is photoelectrically converted to decode the control signal and the main signal, and the decoded main signal is electro-optically converted to be transmitted as the optical signal. The light branched by the branching unit 11 may be detected by the detection unit 12, and the compensation value of the PMD may be inputted to a compensator for performing the polarization compensation as the optical signal.

Thus, the polarization compensation unit 13 can erase the control signal superimposed on the optical signal.

The decoding unit 14 decodes the signal outputted by the detection unit 12 into the bit string.

The control unit 15 controls the optical distribution device 10 on the basis of the control signal decoded by the decoding unit 14.

The control signal generation unit 21 performs the inverse modulation of the modulation of the control signal to be erased by the polarization modulation unit 22 on the basis of the control signal generated by the control unit 15. Further polarization modulation may be performed by an additional control signal. Thus, the optical distribution device 10 can erase an old control signal from the optical signal and superimpose a new control signal.

The optical SW 23 outputs the optical signal outputted from the polarization modulation unit 22 to the optical distribution device 10 or the opposite device facing each other via the optical communication network 30.

The optical SW 23 has a configuration corresponding to the relay unit 16 shown in FIG. 2, FIG. 4, FIG. 5 and FIG. 6. The optical SW 23 may be arranged in the front stage of the branching unit 11, between the branching unit 11 and the polarization compensation unit 13, or between the polarization compensation unit 13 and the polarization modulation unit 22. The polarization modulation unit 22 has a configuration corresponding to the polarization modulation unit 44 of FIG. 2, FIG. 4, FIG. 5 and FIG. 6 in a configuration in which the relay device 50 functions as the control signal multiplexing device M as shown in FIG. 1C. Note that, in the case of the configuration shown in FIG. 6, the polarization modulation unit 22 and the polarization compensation unit 13 are replaced by the DGD modulation unit 45 and the DGD compensation unit 18.

Note that the optical distribution device 10 according to the fifth embodiment includes the polarization compensation unit 13 and the polarization modulation unit 22, respectively, and multiplexes the new control signal after erasing the old control signal, but is not limited to this. For example, in the optical distribution device 10 according to other embodiments, the polarization compensation unit 13 or the polarization modulation unit 19 may simultaneously erase the old control signal and multiplex the new control signal. That is, the polarization compensation unit 13 or the polarization modulation unit 22 according to other embodiments modulates the polarization of the optical signal in accordance with the difference between the old control signal and the new control signal, thereby erasing the old control signal and multiplexing the new control signal at the same time.

Further, in the optical distribution device 10 according to other embodiments, only the control signal may be compensated by the polarization compensation unit 13 to leave the polarization variation. In this case, the configuration of the polarization compensation unit 13 can be simplified.

Further, in the optical distribution device 10 according to other embodiments, the polarization modulation unit 22 may multiplex the new control signal on the optical signal in the modulation pattern different from that of the old control signal while leaving the old control signal. In this case, the optical distribution device 10 may not include the polarization compensation unit 13, or may include the polarization compensation unit 13 that compensates for only the polarization variation without compensating for the control signal.

In addition, in other embodiments, the optical distribution device 10 may transmit the optical signal transparently without performing the OEO conversion. In this case, the optical distribution device 10 may perform the decoding by the decoding unit 14 for detecting the PMD, instead of decoding the main signal.

### OTHER EMBODIMENTS

Although above one embodiment has been described in detail with reference to the drawings, the specific configuration is not limited to the one described above, and various design changes and the like can be made.

In the optical communication system 1 according to the above-described embodiment, the user device 40 generates the control signal and the relay device 50 or the optical distribution device 10 receives the control signal, but is not limited to this. For example, in other embodiments, the optical distribution device 10, the control device 20, the relay device 50, and the like may generate the control signal. In this case, the optical distribution device 10, the control device 20 or the relay device 50 have the same configuration as that of the user device 40 of the above-described embodiment. Further, in other embodiments, the control device 20 and the user device 40 may receive the control signal. For example, in other embodiments, the communication of the control signal may be performed between two user devices 40 directly connected by the optical fiber. For example, one user device 40 may be the ONU, and the other user device 40 may be the OLT. In this case, the control device 20 or the user device 40 has the same configuration as that of the optical distribution device 10 or the relay device 50 of the above-described embodiment.

The optical distribution device 10 according to the above-described embodiment includes the detection unit 12, but is not limited to this. For example, the optical distribution device 10 according to other embodiments may identify the polarization angle by detecting the intensity of one of the p-polarization component and the s-polarization component.

The modulation pattern of the optical communication system 1 according to the above-described embodiment changes the polarization angle or the DGD at a predetermined frequency, but is not limited to this. For example, the modulation pattern according to other embodiments may change the polarization angle at constant angular velocity, and may have different angular velocities or rotational directions between the first modulation pattern and the second modulation pattern.

In addition, for example, when the main signal does not perform the polarization modulation or the polarization multiplexing in other embodiments, a modulation pattern for maintaining a constant polarization angle or a modulation pattern for maintaining a rotation direction of the circular polarization may be used. In this case, the first modulation pattern and the second modulation pattern have different polarization angles or rotation directions. Further, for example, the optical communication system 1 according to other embodiments may superimpose the control signal on the optical signal by combining the first modulation pattern for performing the predetermined polarization modulation and the second modulation pattern for not performing the polarization modulation.

Further, in other embodiments, the main signal for the key distribution of the quantum encryption or the like is not subjected to the polarization modulation by the control signal. In this case, the user device 40 transmits the control signal via a separate transmission means (for example, another wavelength in the same core, another transmission line, or other transmission means such as wireless communication). In this case, the control unit 15 of the optical distribution device 10 switches the control signal to be acquired depending on whether or not the control signal is received by the separate transmission means. For example, when the control signal is received by the separate transmission means, the control unit 15 performs processing in accordance with the control signal, and ignores the control signal outputted from the decoding unit 14. In addition, at this time, the control unit 15 turns off the control of the polarization compensation unit 13 and passes the optical signal without compensation. Thus, it is possible to prevent the polarization modulation of the main signal from being canceled and the quantum encryption from being observed. In addition, when the control signal is not received by the separate transmission means, the control unit 15 performs processing in accordance with the control signal outputted from the decoding unit 14. Note that the control unit 15 may set in advance whether to transmit the control signal by the polarization modulation of the main signal or to transmit the control signal by the separate transmission means without monitoring the reception of the control signal.

The control signal according to the above-described embodiment is superimposed on the optical signal by binary modulation, but is not limited to this. For example, the control signal according to other embodiments may be superimposed on the optical signal by multi-level modulation. Also, the control signal according to the above-described embodiment is differentially encoded, but is not limited to this, for example, when the bit of the control signal is “0”, the modulation may be performed by the first modulation pattern, and when the bit of the control signal is “1”, the modulation may be performed by the second modulation pattern. Further, the control signal according to other embodiments may be superimposed by analogue modulation.

In the above-described embodiment, the case where the optical communication system 1 has the configuration shown in FIG. 1B has been described, but the configuration of the optical communication system 1 is not limited to this. For example, when the optical communication system 1 according to other embodiments has the configuration shown in FIG. 1A, the user device 40 (user device 40 on the receiving side) functioning as the control signal receiving device R has a main signal receiving unit instead of the relay unit 16 of the relay device 50 shown in FIG. 2, FIG. 4, FIG. 5 and FIG. 6. In addition, the branching unit 11 may branch the photoelectrically converted electric signal instead of branching the optical signal as it is by the optical merging/branching unit, or may also share the processing circuit of the electric signal as shown in FIG. 8.

Further, for example, when the optical communication system 1 according to other embodiments has the configuration shown in FIG. 1C, the relay device 50 functioning as the control signal multiplexing device M has a configuration in which the optical signal from a preceding device is inputted to the polarization modulating unit instead of the main signal modulation unit 41 of the user device 40 shown in FIG. 2, FIG. 4, FIG. 5 and FIG. 6.

### <Computer Configuration>

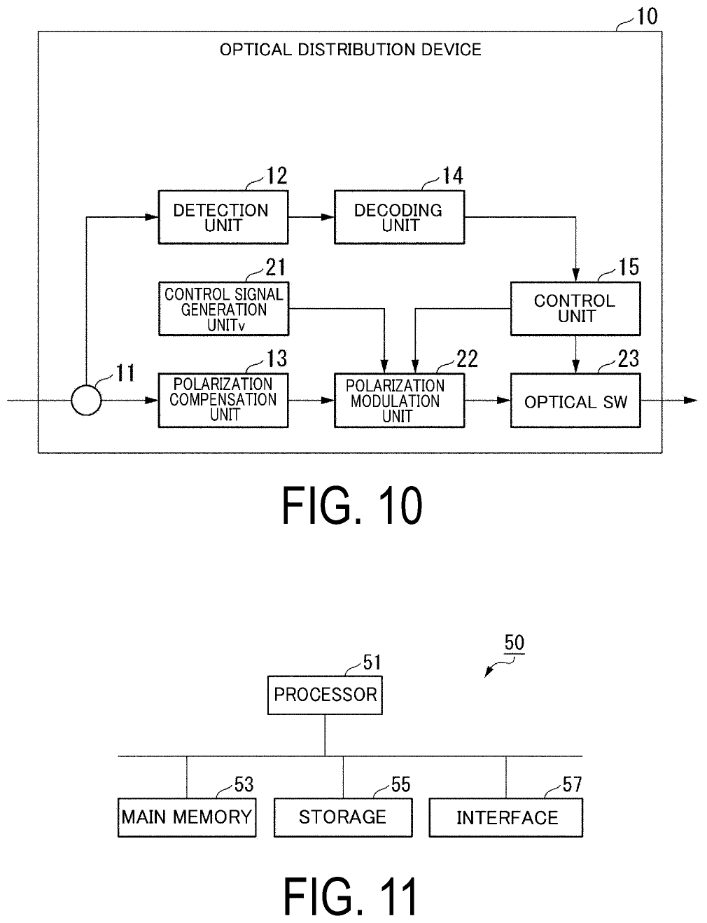

FIG. 11 is a schematic block diagram showing a configuration of a computer according to at least one embodiment.

A computer 70 includes a processor 71, a main memory 73, a storage 75, and an interface 77.

The above-described optical distribution device 10, user device 40 and relay device 50 are mounted on the computer 70. Then, operations of each of the above-described processing units are stored in the storage 75 in the form of a program. The processor 71 reads out the program from the storage 75 and develops the program to the main memory 73 to execute the above-described processing in accordance with the program. Further, the processor 71 secures a storage area corresponding to each of the above-described storage units in the main memory 73 in accordance with the program. Examples of the processor 71 include a CPU (Central Processing Unit), a GPU (Graphic Processing Unit), a microprocessor, and the like.

The program may be used to realize some of the functions to be performed by the computer 70. For example, the program may be combined with other programs already stored in the storage or combined with other programs mounted in other devices to perform the functions. Note that, in other embodiments, the computer 70 may include a custom LSI (Large Scale Integrated Circuit) such as a PLD (Programmable Logic Device) in addition to the above-described configuration or instead of the above-described configuration. Examples of PLD include a PAL (Programmable Array Logic), a GAL (Generic Array Logic), a CPLD (Complex Programmable Logic Device), and an FPGA (Field Programmable Gate Array). In this case, some or all of the functions realized by the processor 71 may be realized by the integrated circuit. Such an integrated circuit is also included in an example of the processor.

Examples of the storage 75 include a magnetic disk, a magneto-optical disk, an optical disc, a semiconductor memory, and the like. The storage 75 may be an internal medium directly connected to a bus of the computer 70 or an external medium connected to the computer 70 via the interface 77 or a communication line. In addition, when the program is distributed to the computer 70 via the communication line, the computer 70 receiving the distribution may develop the program in the main memory 73 and execute the above-described processing. In at least one embodiment, the storage 75 is a non-transitory, tangible storage medium.

Also, the above-described program may realize some of the above-described functions. In addition, the program may be a so-called difference file (difference program), which realizes some of the above-described functions in combination with other programs already stored in the storage 75.

### REFERENCE SIGNS LIST

1 Optical communication system
10 Optical distribution device
11 Branching unit
12 Detection unit
121 PBS
122 First light receiver
123 Second light receiver
13 Polarization compensation unit
14 Decoding unit
15 Control unit
16 Relay unit
17 Compensation amount derivation unit
18 DGD compensation unit
21 Control signal generation unit
22 Polarization modulation unit
23 Optical SW
20 Control device
30 Optical communication network
40 User device
41 Main signal modulation unit
42 Control signal generation unit
44 Polarization modulation unit
441 PBS
442 First quarter-wavelength plate
443 First reflection mirror
444 Second quarter-wavelength plate
445 Second reflection mirror
446 Actuator
Ax First adder
Ay Second adder
Pxx First FIR filter
Pxy Second FIR filter
Pyx Third FIR filter
Pyy Fourth FIR filter
Ux First update unit
Uy Second update unit
70 Computer
71 Processor
73 Main memory
75 Storage
77 Interface

1. A control signal multiplexing device comprising:
a modulator configured to perform polarization modulation of an optical signal for carrying a main signal with a control signal.

2. The control signal multiplexing device according to claim 1, wherein
the modulator performs the polarization modulation of the optical signal by switching a modulation pattern based on the control signal, and
in the modulation pattern, a range of a polarization angle is wider than a range of polarization variation which may occur in a transmission line of the optical signal, or a frequency of change of the polarization angle is higher than a frequency of the polarization variation.

3. The control signal multiplexing device according to claim 2, wherein
the modulation pattern has a frequency or a variation range capable of polarization compensation in a device of a transmission destination of the optical signal.

4. The control signal receiving device comprising:
a decoder configured to decode a control signal based on a polarization state of an optical signal for carrying a main signal.

5. The control signal receiving device according to claim 4, comprising:
a compensator configured to compensate for polarization of the optical signal; and
a modulator configured to perform polarization modulation of the optical signal whose polarization is compensated by a new control signal.

6. A control signal multiplexing or decoding method comprising:
performing polarization modulation of an optical signal for carrying a main signal with a control signal or decoding a control signal based on a polarization state of an optical signal for carrying a main signal.

7. (canceled)
